(19) United States
(12) Patent Application Publication
(10) Pub. No.: US 2022/0010946 A1
(43) Pub. Date: Jan. 13, 2022

(54) BULB FIXING AND CLAMPING DEVICE

(71) Applicant: DONGGUAN CITY MINLEON ELECTRONICS CO., LTD., Guangdong (CN)

(72) Inventor: Dongchang Chen, Guangdong (CN)

(73) Assignee: DONGGUAN CITY MINLEON ELECTRONICS CO., LTD., Guangdong (CN)

(21) Appl. No.: 17/145,401

(22) Filed: Jan. 11, 2021

(30) Foreign Application Priority Data
Jul. 13, 2020 (CN) 202021365418.X

(51) Int. Cl. F21V 17/16; F21V 21/088

(52) U.S. Cl. CPC F21V 17/164; F21V 21/088

(57) ABSTRACT

A bulb fixing and clamping device includes a bottom plate, a clamping plate, a supporting plate, and a bulb mounting seat. A first end of the bottom plate is fixedly connected to a first end of the supporting plate. A first end of the clamping plate is fixedly connected to a second end of the supporting plate and the bulb mounting seat. A second end of the bottom plate and a second end of the clamping plate are located on a same side. The bottom plate includes a strip-shaped hole located directly below the clamping plate. A tip of the second end of the clamping plate includes a buckle groove having an open end flush with a surface of the clamping plate and another end extending in a direction of the strip-shaped hole. The bulb mounting seat includes a mounting hole having an inner wall including triangular grooves.

### CROSS-REFERENCE TO RELATED APPLICATION

This application claims the priority benefit of China application serial no. 202021365418.X, filed on Jul. 13, 2020. The entirety of the above-mentioned patent application is hereby incorporated by reference herein and made a part of this specification.

### BACKGROUND

### Technical Field

The disclosure relates to the technical field of bulb mounting, and more particularly to a bulb fixing and clamping device.

### Description of Related Art

A bulb is generally composed of a bulb cover and a bulb cap, and the bulb cap and the bulb cover are threadedly connected. During mounting and fixation, a bulb mounting seat may be placed between the bulb cap and the bulb cover. When the bulb cap and the bulb cover are threadedly connected, the bulb mounting seat is restricted between the two, thereby realizing the fixation of the bulb mounting seat and the bulb. The bulb mounting seat is generally used to form a bulb fixing and clamping device in cooperation with a clamping structure, so that the bulb may be used in a specific scenario. The conventional bulb fixing and clamping device has a complicated structure and requires cumbersome operation, and the bulb mounting seat thereon is only applicable to bulbs of specific sizes and has poor versatility.

### SUMMARY

The disclosure provides a bulb fixing and clamping device, which has a simple structure, allows for convenient operation, is applicable to bulbs of various sizes, and has good versatility.

In order to achieve the above, the disclosure provides the following technical solutions.

A bulb fixing and clamping device includes a bottom plate, a clamping plate, a supporting plate, and a bulb mounting seat. A first end of the bottom plate is fixedly connected to a first end of the supporting plate, and a first end of the clamping plate is respectively fixedly connected to a second end of the supporting plate and the bulb mounting seat, and a second end of the bottom plate and a second end of the clamping plate are located on a same side. The bottom plate is provided with a strip-shaped hole, and the strip-shaped hole is located directly below the clamping plate. A tip of the second end of the clamping plate is provided with a buckle groove, and an open end of the buckle groove is flush with a surface of the clamping plate, and another end of the buckle groove extends in a direction of the strip-shaped hole. The bulb mounting seat is provided with a mounting hole, and an inner wall of the mounting hole is provided with multiple triangular grooves.

In an embodiment, an included angle between a plane where the bulb mounting seat is located and a plane where the clamping plate is located is 22°.

In an embodiment, an included angle between the supporting plate and the clamping plate is 90°, and an included angle between the bottom plate and the supporting plate is less than 90°.

In an embodiment, a tip of the second end of the bottom plate is connected with an anti-slip member, and the anti-slip member is provided with an anti-slip pattern thereon, and the anti-slip member is disposed parallel to the clamping plate.

In an embodiment, the anti-slip member is integrally formed as one piece with the bottom plate.

In an embodiment, right angle reinforcing plates are respectively provided on both sides of the first end of the supporting plate, and two right angle sides of each of the right angle reinforcing plates are respectively connected to the supporting plate and the bottom plate.

In an embodiment, the bottom plate, the clamping plate, the supporting plate and the bulb mounting seat are integrally formed as one piece.

In an embodiment, the mounting hole includes a larger hole and a smaller hole that are communicated with each other, and a diameter of the larger hole is greater than a diameter of the smaller hole, and the smaller hole is disposed close to the clamping plate.

The bulb fixing and clamping device of the disclosure includes only components such as the bottom plate, the clamping plate, the supporting plate, and the bulb mounting seat, and the structure is simple. When the bulb fixing and clamping device is in use, the buckle groove end is inserted into a specific mounting position. At this time, the clamping plate will be slightly embedded in the strip-shaped hole under force. When the clamping plate and the bottom plate are inserted into a certain position, the clamping plate is reset to make the buckle groove buckled with a fastener in the mounting position to realize the fixation mounting of the bulb fixing and clamping device, and the operation is convenient. The inner wall of the mounting hole is provided with the multiple triangular grooves, so that the bulb fixing and clamping device may be applicable to bulbs of various sizes and has good versatility.

### BRIEF DESCRIPTION OF THE DRAWINGS

FIG. 1 is a schematic diagram of the structure of a bulb fixing and clamping device in an embodiment.

FIG. 2 is a side view of the bulb fixing and clamping device in FIG. 1.

FIG. 3 is a schematic diagram of the structure of a bulb fixing and clamping device in another embodiment.

### DESCRIPTION OF THE EMBODIMENTS

Hereinafter, the technical solutions in the embodiments of the disclosure will be clearly and fully described with reference to the accompanying drawings in the embodiments of the disclosure. It is apparent that the described embodiments are only a part of the embodiments of the disclosure, and not all embodiments. Based on the embodiments of the disclosure, all other embodiments obtained by persons of ordinary skill in the art without creative work shall fall within the claimed scope of the disclosure.

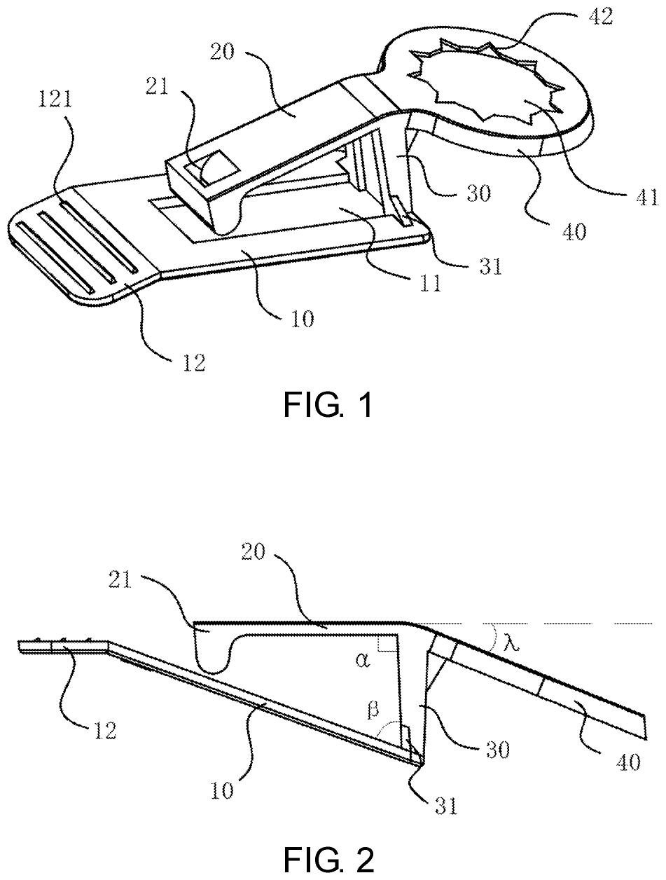

FIG. 1 is a schematic diagram of the structure of a bulb fixing and clamping device in an embodiment. The bulb fixing and clamping device includes a bottom plate 10, a clamping plate 20, a supporting plate 30, and a bulb mounting seat 40. A first end of the bottom plate 10 is fixedly connected to a first end of the supporting plate 30. A first end of the clamping plate 20 is respectively fixedly connected to a second end of the supporting plate 30 and the bulb mounting seat 40. A second end of the bottom plate 10 and a second end of the clamping plate 20 are located on the same side. Specifically, the bottom plate 10, the clamping plate 20, the supporting plate 30 and the bulb mounting seat 40 are integrally formed as one piece. As shown in FIG. 2, the included angle a between the supporting plate 30 and the clamping plate 20 is 90°, and the included angle β between the bottom plate 10 and the supporting plate 30 is less than 90°. The included angle λ between the plane where the bulb mounting seat 40 is located and the plane where the clamping plate 20 is located is 22°.

The bottom plate 10 is provided with a strip-shaped hole 11, and the strip-shaped hole 11 is located directly below the clamping plate 20. A tip of the second end of the clamping plate 20 is provided with a buckle groove 21, and an open end of the buckle groove 21 is flush with the surface of the clamping plate 20, and another end of the buckle groove 21 extends in the direction of the strip-shaped hole 11. The bulb mounting seat 40 is provided with a mounting hole 41, and the inner wall of the mounting hole 41 is provided with multiple triangular grooves 42.

The bulb fixing and clamping device in the embodiment includes only components such as the bottom plate 10, the clamping plate 20, the supporting plate 30, and the bulb mounting seat 40, and the structure is simple. When the bulb fixing and clamping device is in use, an end formed with the buckle groove 21 is inserted into a specific mounting position. At this time, the clamping plate 20 will be slightly embedded in the strip-shaped hole 11 under force. When the clamping plate 20 and the bottom plate 10 are inserted into a certain position, the clamping plate 20 is reset to make the buckle groove 21 buckled with a fastener in the mounting position to realize the fixation mounting of the bulb fixing and clamping device, and the operation is convenient. The inner wall of the mounting hole 41 is formed with the multiple triangular grooves 42, so that the bulb fixing and clamping device may be applicable to bulbs of various sizes and has good versatility.

In an embodiment, the tip of the second end of the bottom plate 10 is connected with an anti-slip member 12. The anti-slip member 12 is provided with an anti-slip pattern 121 thereon, and the anti-slip member 12 is disposed parallel to the clamping plate 20. Specifically, the anti-slip member 12 is integrally formed as one piece with the bottom plate 10, and the anti-slip member 12 is disposed at the tail end of the bottom plate 10, which may strengthen the stability of the buckle.

In an embodiment, right angle reinforcing plates 31 are respectively provided on both sides of the first end of the supporting plate 30. Two right angle sides of each of the right angle reinforcing plates 31 are respectively connected to the supporting plate 30 and the bottom plate 10. The right angle reinforcing plates 31 have a reinforcing effect on the connection between the supporting plate 30 and the bottom plate 10, thereby preventing breaking when the supporting plate 30 is bent.

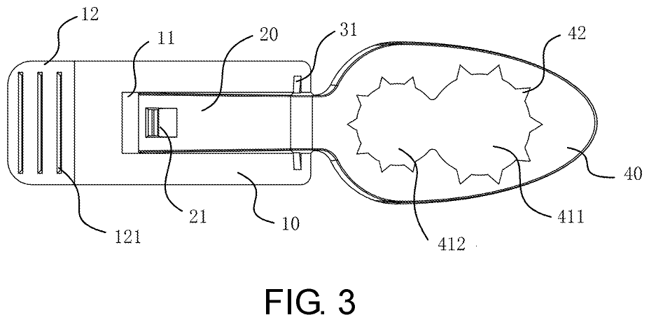

In an embodiment as shown in FIG. 3, the mounting hole 41 includes a larger hole 411 and a smaller hole 412 that are communicated with each other. A diameter of the larger hole 411 is greater than a diameter of the smaller hole 412. The smaller hole 412 is disposed close to the clamping plate 20. The bulb fixing and clamping device in the embodiment is provided with both the larger hole 411 and the smaller hole 412 having the triangular grooves 42, which further expands the scope of application and is applicable to bulbs of more sizes.

The bulb fixing and clamping device of the disclosure has a simple structure, allows for convenient operation, has good mounting stability, is applicable to bulbs of various sizes, and has good versatility.

The above embodiments are only several exemplary embodiments of the disclosure, and their descriptions are relatively specific and detailed. It should be understood that the disclosure is not limited to the forms disclosed herein. The embodiments should not be regarded as an exclusion of other embodiments, but may be used in various other combinations, modifications, and environments. In addition, the embodiments may be modified according to the above teachings or the technology or knowledge in the related fields within the concept scope of the disclosure described herein, which should not be understood as limiting the scope of the disclosure. It should be noted that for persons of ordinary skill in the art, several modifications and improvements may be made without departing from the concept of the disclosure, and the alterations and changes made by persons of ordinary skill in the art do not depart from the spirit and scope of the disclosure, which all belong to the protection scope of the appended claims of the disclosure. Therefore, the claimed scope of the disclosure should be defined by the appended claims.

What is claimed is:

1. A bulb fixing and clamping device, comprising:
a bottom plate;
a clamping plate;
a supporting plate; and
a bulb mounting seat,
wherein a first end of the bottom plate is fixedly connected to a first end of the supporting plate, a first end of the clamping plate is fixedly connected to a second end of the supporting plate and the bulb mounting seat, and a second end of the bottom plate and a second end of the clamping plate are located on a same side,
wherein the bottom plate is provided with a strip-shaped hole, and the strip-shaped hole is located directly below the clamping plate,
wherein a tip of the second end of the clamping plate is provided with a buckle groove, an open end of the buckle groove is flush with a surface of the clamping plate, and another end of the buckle groove extends in a direction of the strip-shaped hole, and
wherein the bulb mounting seat is provided with a mounting hole, and an inner wall of the mounting hole is provided with a plurality of triangular grooves.

2. The bulb fixing and clamping device according to claim 1, wherein an included angle between a plane where the bulb mounting seat is located and a plane where the clamping plate is located is 22°.

3. The bulb fixing and clamping device according to claim 1, wherein an included angle between the supporting plate and the clamping plate is 90°, and an included angle between the bottom plate and the supporting plate is less than 90°.

4. The bulb fixing and clamping device according to claim 1, wherein a tip of the second end of the bottom plate is connected with an anti-slip member, the anti-slip member is provided with an anti-slip pattern thereon, and the pattern is disposed parallel to the clamping plate.

5. The bulb fixing and clamping device according to claim 4, wherein the pattern is integrally formed as one piece with the bottom plate.

6. The bulb fixing and clamping device according to claim 1, wherein right angle reinforcing plates are respectively provided on both sides of the first end of the supporting plate, and two right angle sides of each of the right angle reinforcing plates are respectively connected to the supporting plate and the bottom plate.

7. The bulb fixing and clamping device according to claim 1, wherein the bottom plate, the clamping plate, the supporting plate and the bulb mounting seat are integrally formed as one piece.

8. The bulb fixing and clamping device according to claim 1, wherein the mounting hole comprises a larger hole and a smaller hole that are communicated with each other, a diameter of the larger hole is greater than a diameter of the smaller hole, and the smaller hole is disposed close to the clamping plate.
